(19) United States
(12) Patent Application Publication
(10) Pub. No.: US 2020/0162899 A1
(43) Pub. Date: May 21, 2020

(54) SYSTEMS, DEVICES, AND METHODS FOR MANAGING AND CONTROLLING A DEVICE BASED ON LOCATION

(71) Applicants: Katharine Brandes, New York, NY (US); Jack Breslauer, Brooklyn, NY (US); Theodore Ellis, Seattle, WA (US)

(72) Inventors: Katharine Brandes, New York, NY (US); Jack Breslauer, Brooklyn, NY (US); Theodore Ellis, Seattle, WA (US)

(21) Appl. No.: 16/538,256

(22) Filed: Aug. 12, 2019

Related U.S. Application Data
(60) Provisional application No. 62/729,819, filed on Sep. 11, 2018.

(51) Int. Cl. H04W 12/00; H04W 12/08; G06F 21/55; G06F 21/86; H04W 12/06; H04W 4/029

(52) U.S. Cl. CPC H04W 12/00503; H04W 12/0027; H04W 12/0802; H04W 12/00502; G06F 2221/034; G06F 21/86; H04W 12/06; H04W 4/029; G06F 21/554

(57) ABSTRACT

Systems, devices and methods for managing and controlling a device based on location. The systems, devices, and methods track a device entering and leaving a geofence, then manage and control features and applications on the device.

### CROSS REFERENCE TO RELATED APPLICATIONS

The present application claims priority pursuant to U.S.C. § 119(e) to U.S. Provisional Patent Application No. 62/729,819 filed Sep. 11, 2018, the entire content and disclosure of which is hereby incorporated by reference in its entirety.

The present application is related to U.S. Provisional Patent Application No. 62/780,008 filed Dec. 14, 2018, the entire content and disclosure of which are hereby incorporated by reference in their entireties.

### FIELD

The subject matter described herein relates generally to systems, devices, and methods for managing and controlling a device based on location. In particular, the systems, devices, and methods track a device entering and leaving a geofence, then manage and control features and applications on the device.

### BACKGROUND

Statistics have shown that most users are hooked on smartphones. The average smartphone user glances at her phone 80 times a day (30,000 times a year). The most recent studies show average mobile device usage of 4 to 5 hours per day, but this figure is increasing at a double-digit percentage year-over-year. Yet 40% of the time users unlock their smartphones they are not consciously aware of the reason they are doing so. Teenagers are perhaps the most hooked on their smartphones: 50% describe themselves as addicted and 78% check their devices at least hourly. Some of the consequences of excessive smartphone use are the following.

Less social: The number of teens who get together with their friends nearly every day dropped by more than 40 percent from 2000 to 2015. Specifically, 12th-graders in 2015 were going out less often than eighth-graders did in 2009 (the pre-iPhone era). Only about 56 percent of high-school seniors in 2015 went out on dates; for Boomers and Gen Xers, the number was about 85 percent.

More depressed: Boys' depressive symptoms increased by 21 percent in the 3 years from 2012 to 2015, while girls' depressive symptoms increased by 50 percent. Teens who spend three hours a day or more on electronic devices are 35 percent more likely to have a risk factor for suicide, such as making a suicide plan.

Suffering in the classroom: Classrooms that ban cell phones show test score improvements of 6.4% (with low-scoring students improving even more, by 14.2%). Smartphones don't just distract in the classroom: 8th, 10th, and 12th graders in the 2010s spend less time on homework than Gen X teens did as recently as the early 1990s.

Most American adults will readily share anecdotal evidence of shortening attention spans and diminished workplace productivity. Studies have shown a decline in cognitive abilities equivalent to 10 IQ points when a phone is simply physically present. In fact, in controlled studies even increasing proximity to the phone (in a pocket vs. on a table vs. in another room) leads to reduced performance on tests of cognitive abilities.

Parents routinely express concern about their children's use of devices, such as smartphones. However, the vast majority of people are currently addressing these concerns with either denial or “home-made” remedies. Only 47% of people do anything to address smartphone distraction. A 2017 Deloitte study captured the various ways in which consumers try to limit distraction, as shown in FIG. 1.

Thus, needs exist for systems, devices and methods for managing and controlling devices, such as smartphones, without the above mentioned and other disadvantages. These systems, devices and methods may manage and control the devices and their use based on location, or the use of geofencing.

### SUMMARY

Provided herein are example embodiments of systems, devices and methods for managing and controlling a device based on location. In particular, the systems, devices, and methods track a device entering and leaving a geofence, then manage and control features and applications on the device. It should be noted that the present disclosure is not limited to a school or a workplace environment. As such, although for brevity, examples may refer to a school environment and student users, they may also apply to workplace environment and worker users, or to other suitable environments and users.

In some embodiments, the present disclosure may include a computer-based method for managing and controlling a user device based on location, comprising: defining one or more policy definitions, storing the one or more policy definitions in a database, activating an application on the user device based on the location of the user device, retrieving the one or more policy definitions, receiving telemetry information of the user device, wherein the telemetry information includes at least screen time data, updating status of the user device in the database, based on the telemetry information, transmitting a push notification to the user device; and locking the user device based on the one or more policy definitions.

In some embodiments, the location of the user device may indicate the user device enters a defined geographic area. The policy definitions may include at least one of a period of time the application can be activated, activities allowed when the application is activated, actions to perform when the user device is not in compliance, and geofencing configurations. The period of time the application can be activated may include one or more blocks of time a user of the user device is in class or is at work.

In some embodiments, the actions to perform when the user device is not in compliance may include one of locking the user device, transmitting a warning to the user device, and notifying a third person. The user is not in compliance may include one of the user attempting to tamper with or disable the application, or the user disabling a location service on the user device.

In some embodiments, the computer-based method may further provide a randomly generated passcode to disable the locking of the user device.

In some embodiments, locking the user device may include disabling at least one of one or more third-party applications, Internet connection, and a camera. Locking the user device may not include disabling at least one of voice calling, text messaging, and one or more native functions of the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated in and constitute a part of the specification, are for illustrative purposes only of selected embodiments, serve to explain the principles of the invention. These drawings do not describe all possible implementations and are not intended to limit the scope of the present disclosure.

FIG. 1 illustrates the various ways in which consumers try to limit distraction.

FIG. 2 illustrates an exemplary high-level diagram of an architecture of the present disclosure, according to some embodiments.

FIG. 3 illustrates an exemplary high-level diagram of the server-side Policy Engine, according to some embodiments.

FIG. 3A illustrates an exemplary flow diagram for detecting a user has removed the application from his/her device, according to some embodiments.

FIG. 4 illustrates an exemplary high-level diagram of the client-side application, according to some embodiments.

FIG. 5 illustrates an exemplary high-level diagram of geofencing, according to some embodiments.

FIGS. 6 to 16B illustrate exemplary graphical user interfaces (GUI) of a mobile application, according to some embodiments.

FIG. 17 illustrates an exemplary overall system architecture, according to some embodiments.

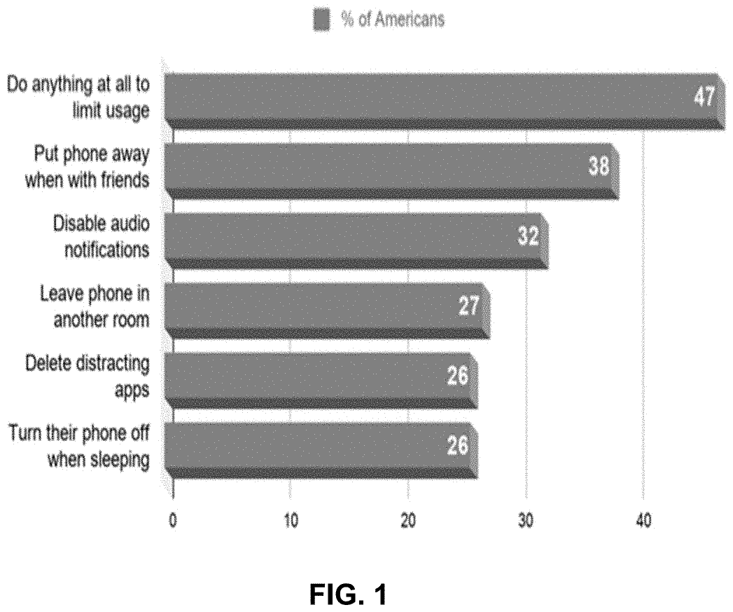

### DETAILED DESCRIPTION

Provided herein are example embodiments of systems, devices and methods for managing and controlling a device based on location. In particular, the systems, devices, and methods track a device entering and leaving a geofence, then manage and control features and applications on the device.

In some embodiments, the present disclosure may generally provide a system for managing screen time use in a real-world large group, for example, schools or workplaces. As used herein, screen time means the amount of time a user has been on the user device. The system may allow the use of authority figures and social pressures of existing real-world groups to reduce screen time. The system may allow management of thousands of devices, for example across wireless Android or iOS devices and the like, all managed from a web-based administrator dashboard.

In some embodiments, the present disclosure may provide a device management and control application (which, for simplicity, may be referred to as application or “app”) installed on wireless devices, for example devices that K-12 students bring to school or workers bring to workplace. The wireless devices may include smart wearables such as smartphones, smartwatches, smart glasses, etc. In some embodiments, the application may count screen time (e.g., in minutes) during class or in a predetermined location, and may, when necessary, restrict access to the Internet, social media, other apps, etc.

In some embodiments, an administrator, e.g., the school's principal may set class periods with policies (e.g., first period, second period, etc., with breaks for lunch and for getting between classes), or the office manager may set work periods with policies. When the user's phone detects it is on school campus (e.g., via a geofence) and within a class period, then the core capabilities of the application may be activated.

Exemplary features of the system of the present disclosure may include:

1. Ability to use a randomly generated passcode to disable the application's block (but may allow teachers/employers to use smartphones in class/workplace for instructional/work purposes).

2. Ability to segment users into groups and apply different schedules, geofences, and policies to those groups (e.g., 9th grade is blocked after using their devices 8 minutes/day, 12th grade is blocked after using their devices 20 minutes/day, worker performing critical task is blocked in a predetermined location, etc.).

3. Ability to aggregate usage data from large groups into group or institutional level analysis and charts.

4. Ability for administrator to choose whether users are sent notifications about their usage or not.

5. Peer comparison of device (e.g., smartphone) use within the group (leaderboards, group average, etc.).

6. Flexible notification scheduler−the ability for a school/workplace to customize a ‘journey’ of notifications as a student/worker accumulates more screen time, approaches, and then exceeds a lock limit.

7. Notifications that are written by a professional, e.g., psychologists, to guide more self-aware device (e.g., smartphone) behavior.

8. Integrating a goal setting component, either on an individual or group level.

9. Integration with school enrollment systems (SIS) and learning management systems (LMS) to provide an additional metric of student engagement.

10. Integrating with attendance-taking processes (e.g., using application to document student and teacher attendance).

11. Integrating with detailed usage data and tools provided by the Digital Wellness™ suite on Android, or the Screen Time™ suite on iOS, and the like. These may be made available via API/SDK.

12. Customizing schedules and policies to specific geofences (for example, to allow different rules when the user is at work, or when the user is at home, or at the gym, etc.).

13. Incorporating an attendance or time stamping system, for example to allow students with the application to declare themselves present at school.

14. AI-driven recommendations on schedule and policy setting (e.g., if the user is a school of X size of Y grades in Z location, the system may know that configuration A is optimal for reducing phone usage).

15. Using machine learning algorithms on application data to determine the most effective individual interventions to reduce use of smart device, e.g., smartphone use.

In some embodiments, the system of the disclosure may have two main core capabilities: tracking and lock mode. In the tracking mode, the system of the disclosure may track the number of times a user unlocks his/her device and for how long (e.g., how many minutes) the user uses the device. In some embodiments, tracking may be active only when a user is within a defined geofence and during a class/workplace mode period, as set by the administrator. Other configurations may also be possible.

In some embodiments, in the lock mode, apps, Internet access, and camera may be blocked during a window of time specified by the administrator. In some embodiments, lock mode may be set to occur after a certain number of time (e.g., certain number of minutes) of tracking, for example after a user has used his/her phone for 5 minutes during a class/workday.

It should be noted that tracking and lock mode are functions that may be used in various configurations and to varying degrees, for example, depending on a school/workplace's philosophy regarding smartphones. Schools or workplaces that have permissive smartphone policies may simply use the screen time tracking functionality to understand how much time students or workers are using their devices in school or at/during work. The schools or workplaces that have strict no-phone policies can use the system of the disclosure to ensure they have a mechanism for enforcing the rules.

In some embodiments, the system may have a ‘Passcode’ or ‘Whitelist’ that may be visible on an administrator dashboard. This code may change on a predetermined time, e.g., every hour (or class period), and may be shared with students or workers. When a student or worker enters the code into his/her phone, the application may be deactivated for the remainder of the period/hour. A purpose of this feature may be to enable teachers or managers to use smartphones for instruction when necessary, while not permitting unfettered smartphone use in school or at workplace. The code may need to change every hour/period so that it may not be shared among users. In some embodiments, the code may be randomly generated.

Policy Definitions

In some embodiments, policy definitions may include schedules when the application applies (e.g., specific periods of time during the school day called “blocks”, optionally not including vacation days), what students are allowed to do in while the application is active (e.g., # of minutes or unlocks of their phone), and what to do when students or workers are out of compliance (e.g., lock phone, issue a warning, or just notify teacher/manager). Policy definitions may also include geofencing configurations, namely one or more specific geographic regions where the application will be active (for example, only when students are physically at their school, or workers at their assigned work locations).

Additional policy options may include for example: (a) measuring the velocity of a device (e.g., the application applies when driving), (b) in-building location indicators (e.g., student or worker is in a specific room based on using location sensors, e.g., Beacon technology), (c) varying which applications are hidden when the phone is locked (e.g., students in science class may have access to science applications).

In a school usage example, a database may track schools, administrators, teachers, parents, students and devices. Students may be grouped by grade, or other characteristics (e.g., students needing extra attention or having disciplinary problems). Each of these groupings of students may have different policies applied. For other use case examples, such as in a workplace, the system may group workers by job category (e.g., do they operate heavy machinery) or location, etc.

Incidents

In some embodiments one or more incidents may occur when a student or worker attempts to tamper with or disable the application to subvert the application policy (for example, removing the application, or turning off “Location Services” so their mobile device does not detect that they have entered their school or workplace). When the system detects an incident based on policy different, the system may generate a response, for example locking the user's phone or reporting the incident to school or workplace administrators, who may manually take further action.

Telemetry/Analytics

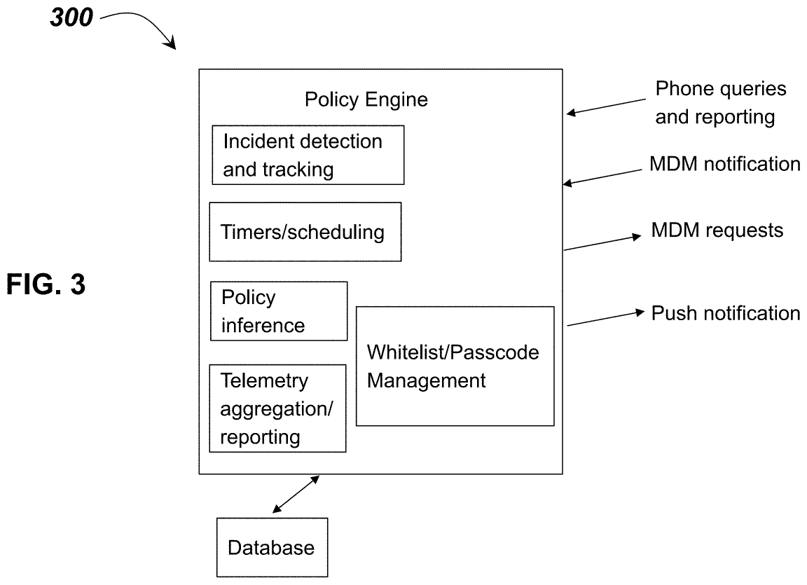

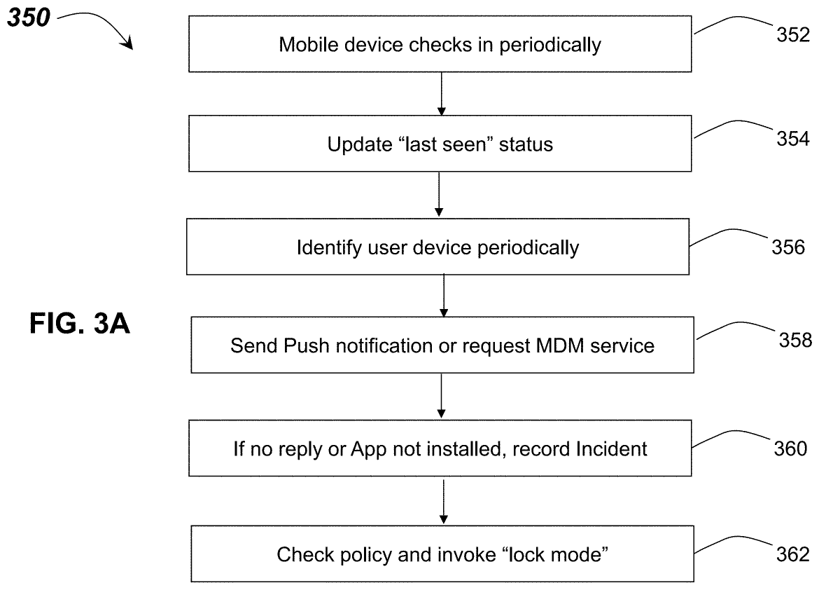

In some embodiments, the system may include a Policy Engine, which will be described further in FIG. 3 below. In some embodiments, the Policy Engine may collect and aggregate telemetry from mobile devices as well as the policy engine itself to provide useful analytic information to administrators, teachers, parents and students, managers and workers, and so on. This information may also be used to provide overall reports on the effectiveness of different types of policies across an entire population of schools or workplaces to address device misuse.

Whitelisting

In some embodiments, the system may allow a teacher or administrator to “whitelist” a device or device(s) (e.g., some or all devices in a class, a work location) to allow students or workers to bypass a policy. For example, a whitelist could allow students to use their phones for an hour because of a school project. Teachers or administrators may also manually “unlock” phones that were locked with the application, or “lock” phones for students that are misbehaving. Teachers may provide a whitelist code which students enter in the application to easily initiate whitelisting.

Mobile Device Management (MDM)

In some embodiments, the system may further include a mobile device management (MDM) component. MDM is a component in the overall architecture which helps to implement at least some of the features of the application on devices that have OS restrictions on what the application can do on the devices. For example, on the iOS platform, MDM may be used to apply policies to the phone to hide user's apps, or to detect if the user has uninstalled the application.

Managing Device Inputs and State

As will be described further in FIG. 3 below, this feature may include managing messages originating from the mobile devices, push notifications from the Policy Engine, and notifications and requests between the Policy Engine and the MDM.

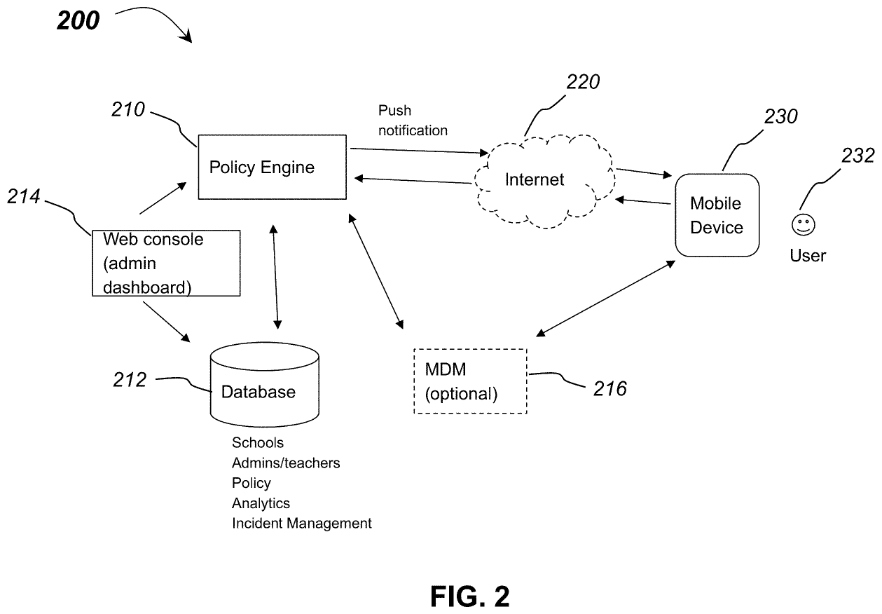

Referring now to FIG. 2, an exemplary high-level diagram of an architecture 200 of the present disclosure is illustrated. The left side of FIG. 2 includes service components, which can be a multi-tenant cloud architecture, or it can be hosted on premise on one or more severs. The service side may comprise a Policy Engine (business logic) 210, a database 212, and a web console 214. The database may be local or distributed. An API (not shown) may also be available for administrators to programmatically control the application and retrieve analytics. A component Mobile Device Management (MDM) service 216, which may be used to help manage mobile devices and will be described further below. In some embodiments, the MDM 216 may be optional.

FIG. 2 further illustrates the network 220, for example the Internet cloud, which provides connectivity to mobile devices. The network may include Wi-Fi, cellular, and/or other wireless and wired connection. Connections to the mobile devices may be intermittent to conserve battery power. In some embodiments the system may utilize push notifications to send a message from a cloud service to the wireless (mobile) devices even when the device is not active, for example in sleep mode. Push notifications may leverage infrastructure provided by the mobile OS providers (e.g., Apple and Google).

FIG. 2 also illustrates the user device 230—which may be a mobile device used, for example by a student 232. It should be noted again that users are not limited to just students, they may also be workers or any person (e.g., persons under a certain age, as in limiting usage for kids). Additionally, while the exemplary embodiment is shown running on mobile devices, this can be used to control usage of other types of devices such as desktop computers, streaming devices, like AppleTV™, etc.

In some embodiments, this architecture may be used for monitoring usage only, and not “locking” the phone down if someone violates policy. This may be used for other use cases such as identifying if someone has not used a device in a while (e.g., in an assisted living facility).

Referring to FIG. 3, an exemplary high-level diagram of the server-side Policy Engine 300 of the present disclosure, according to some embodiments, is illustrated. The Policy Engine may manage policy definitions, provide for recurring timers or scheduled tasks which invoke other components of the engine. In some embodiments, the Policy Engine may include or involve in the features below:

Timers/Scheduling

A core of the Policy Engine may provide for recurring timers or scheduled tasks which invoke other components of the engine. For example, they may fire periodic events to determine that a student's phone has not reported any telemetry data for a period of time and initiate an Incident detection response. The response may include, for example, sending a push notification to the device to check-in, or querying the MDM service to determine whether the application is installed. Another example would be a scheduled “end of application block” when all phones would be unlocked.

Managing Device Inputs and State

As shown in FIG. 3, there are numerous inputs into the Policy Engine. These may include:

Messages originating from the mobile devices which may include telemetry data (usage information), incident detection (e.g., user turned off location services), notices that phones were locked or unlocked, etc. Mobile devices can also periodically request updates to policies.

Push notifications sent from the Policy Engine to mobile devices—these push notifications may be used to tell mobile devices to get updated policies, to detect incidents, to prompt the phone to “unlock” either by a manual intervention by a teacher/administrator or via a “Whitelist”, etc.

MDM Notifications (when an MDM is used)—these notifications may be used to detect Incidents, for example they tell the policy engine when a user as removed the MDM service from his/her phone.

MDM Requests—these may include requests from the Policy Engine to the MDM service for information on the phones (e.g., what applications are installed, do they have a device passcode), and to apply policy (e.g., hide student's applications).

Incident Detection and Tracking

The Policy Engine may monitor the incoming stream of notifications from the mobile devices as well as the MDM service to detect “Incidents”. Some may be direct notifications (e.g., student attempted to remove the application from their phone, or turned off Location Services). Others may be tracked over time (e.g., the system did not hear from the mobile application in 3 days).

Policy Inference

The Policy Engine may implement heuristic algorithms taking inputs from policy definitions, timers/schedulers, incident tracking and whitelist to trigger actions or notifications to the mobile devices or MDM.

In some embodiments, as illustrated in FIG. 3A, an exemplary flow diagram 350 for detecting that a user has removed the application from his/her device and his/her phone needs to be “locked” may include:

(1) At 352, the mobile device may check in periodically, for example by issuing a call to the Policy Engine to get updated policies and report telemetry information about a user's phone usage. At 354, the Incident Detection component may update a “last seen” status for the device in the database.

(2) Periodically, at 356, a timer may be fired which by policy has the Incident Detection component identify user devices which have not been seen for some period of time. Devices that have not been seen are “suspect” (e.g., it may be that the user has not been on the network).

(3) At 358, the Policy Engine may send a Push notification to the application to prompt it to reply. Alternatively, it may request the MDM service to see if the application is still installed on the mobile device.

(4) When the application fails to reply to the push notification, or the MDM service reports that the application is not installed, then at 360 an “Incident” may be recorded in the database.

(5) At 362, the Policy Inference component may interpret the effective policy for the user and may invoke “lock mode” on the device (e.g., instructing the MDM service to hide the user's applications).

(6) In various cases, the incident may be reported to the database and a list of incidents may be provided to an administrator who can review and manually address each incident.

Telemetry Aggregation/Reporting

In some embodiments, the Policy Engine may collect information reported from the mobile devices (e.g., usage) and the Policy Engine itself (e.g., lock events), and aggregate them to be stored in the database. The Policy Engine may provide analytics to school/work management, students and other authorities, third party systems, etc.

Whitelist Management

In some embodiments, the Policy Engine may manage whitelist codes to allow administrators/teachers to generate and process whitelist codes to bypass application policy (e.g., for 1 hour). Whitelist codes may be implemented in a variety of ways which may be unique for this application, for example:

(1) Codes may be generated dynamically in the cloud service and presented to the administrator or teacher. Teachers may write the code on a board and students can enter the code into their application. Application validates the code and alters its policy.

(2) Codes may be a time-based one-time passcode (e.g., TOTP) which the teachers can look-up on their own mobile device and present to the students.

(3) Codes may be delivered as QR codes which can be scanned by students (e.g., on worksheets) to unlock the device.

(4) In some situations, the user's phone may be locked, and they cannot enter their whitelist code. An alternative implementation may be to allow the user to text their whitelist code to a known phone number, which would be forwarded to the cloud service and, based on the code and their originating phone number, may unlock their phone.

(5) A further embodiment may be to leverage the use of local proximity signals (e.g., beacons) such that when they are turned on, all phones in the room may detect the signal and automatically whitelist themselves.

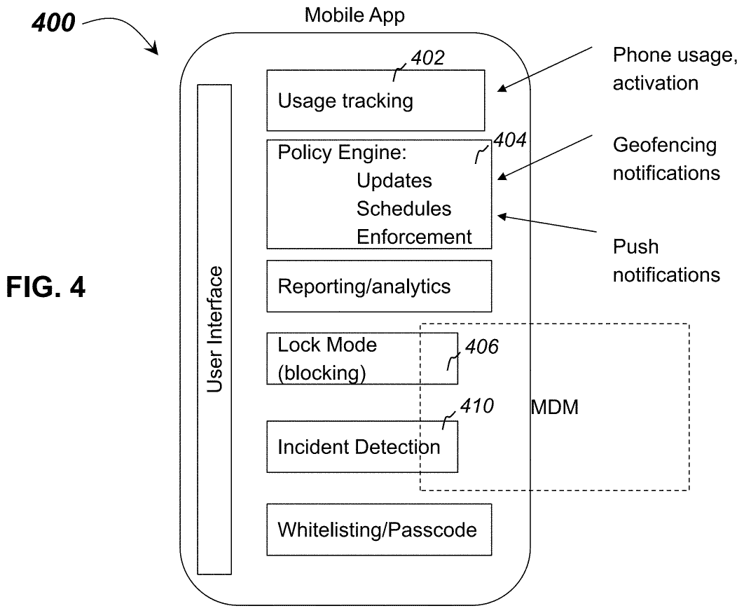

Referring to FIG. 4, an exemplary high-level diagram of the client-side application 400 of the present disclosure is illustrated. FIG. 4 illustrates exemplary key components of an exemplary mobile application. Components with the same name as the server-side Policy Engine implement similar functionality but from the client perspective.

For example, incident detection 410 may monitor activity on the device such as uninstall attempts or the user turning off Location Services. When incidents are identified, the mobile application may send notification to the application service side but may also initiate enforcement action on the local device depending on policy (e.g., send a notification to the user, or block the applications (“lock”)).

Other components on the client side may include:

Usage Tracking

In some embodiments, a usage tracking component 402 may leverage OS-specific implementations to track the usage of a mobile device (e.g., number of unlocks or timers to track how long a phone has been used). It may be responsive to user activity indicators.

Lock Mode

In some embodiments, a lock mode component 406 may also be OS-specific and may handle hiding applications that the user should not use when he/she has violated policy and policy dictates the phone should be locked. On Android this may involve blocking the ability of new apps from starting, while on iOS this may involve interacting with the application service and the MDM component to apply “app hiding” policies to the phone. On other OS, suitable actions may be taken. The dotted line for MDM covering part of lock mode. The MDM mode may also be involved with incident detection.

Policy Engine

In some embodiments, inputs from usage tracking, whitelisting and incident detection may be assimilated by a Policy Engine 404 to determine the proper state (e.g., if the user has used the phone too long, should it lock, or “are we in Application Mode”?). Additional to the Policy Engine include push notifications from the application service (e.g. to pick up new policy), as well as geofencing notifications from the OS.

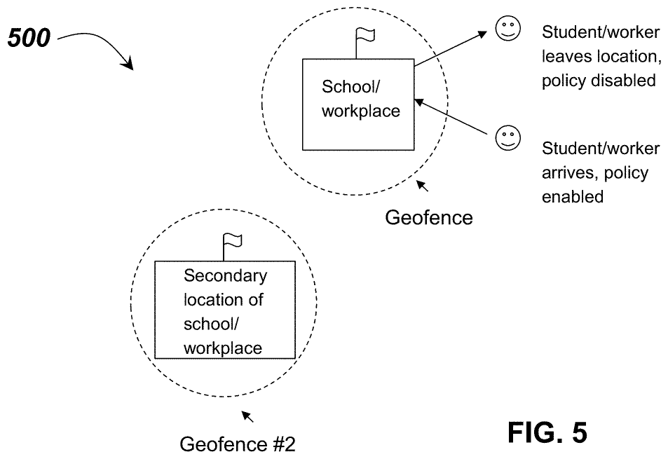

Referring to FIG. 5, an exemplary high-level diagram 500 of geofencing of the present disclosure, according to some embodiments, is illustrated. A geofence is a geographic region typically defined as a location and a distance from that location (e.g., a circle, but can also be other shapes). Modern mobile devices include positioning hardware that leverage GPS signals as well as mapping from nearby Wi-Fi signals to identify a user's location.

An application policy may define one or more geofence regions where the mobile device needs to be located for application policy to apply (in addition or alternatively, may define locations where it does not apply). When a user enters or leaves a geofence, a notification may be sent to the Policy Engine on the mobile device to interpret.

In an exemplary operation, the process may include:

(1) Student arrives at school on the bus and enters the school. She/he has entered the geofence for the school as defined by the administration.

(2) Based on defined policy, the application may apply during school hours when students are in the school—so with both conditions met application policy is now “on”.

(3) In this policy example, students are limited to only a limited time (e.g., 30 minutes) of phone usage a day. When the student uses the phone for more than the limited time (e.g., 30 minutes), the policy engine may apply the Lock Mode policy to the phone and hide all applications on the phone.

(4) Mid-day, the student leaves school early for an appointment. When he/she leaves the campus, the geofence notifies the policy engine that he/she is no longer at school. The policy engine may evaluate its state and release the “lock” mode, re-enabling all applications for the student.

In some embodiments, there may be multiple geofences defined. Alternative embodiments would be to have the application applies all the time except when in a geofence. In some embodiments, non-GPS fences may be used, such as the present or absence of a micro-location service (e.g., beacon) as described above in Policy definitions under “alternative policy options”.

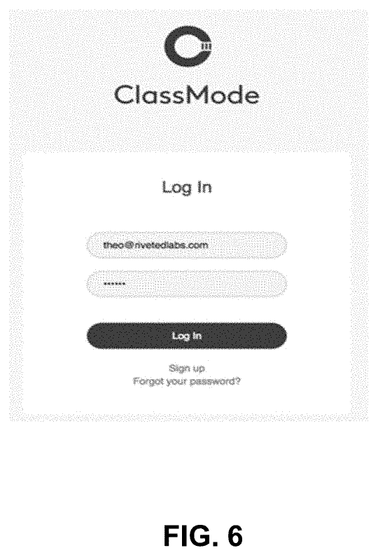

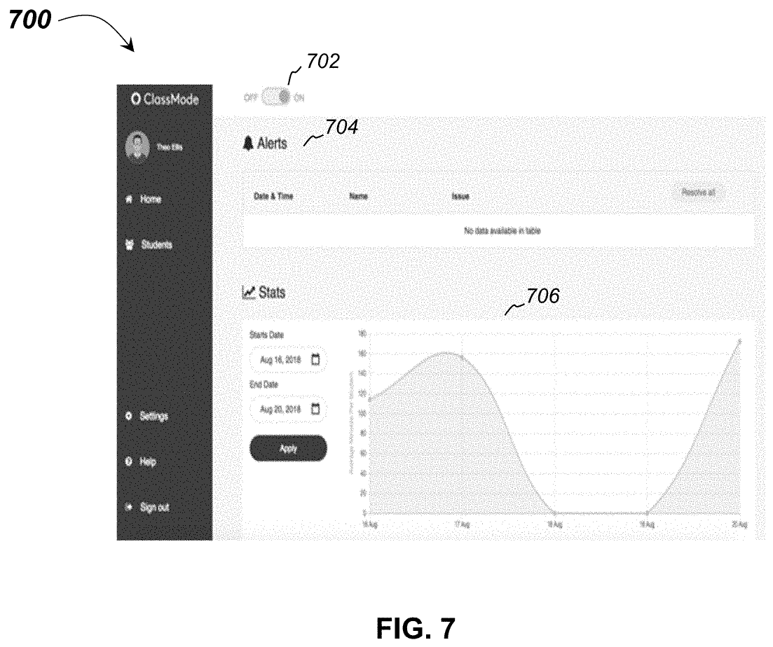

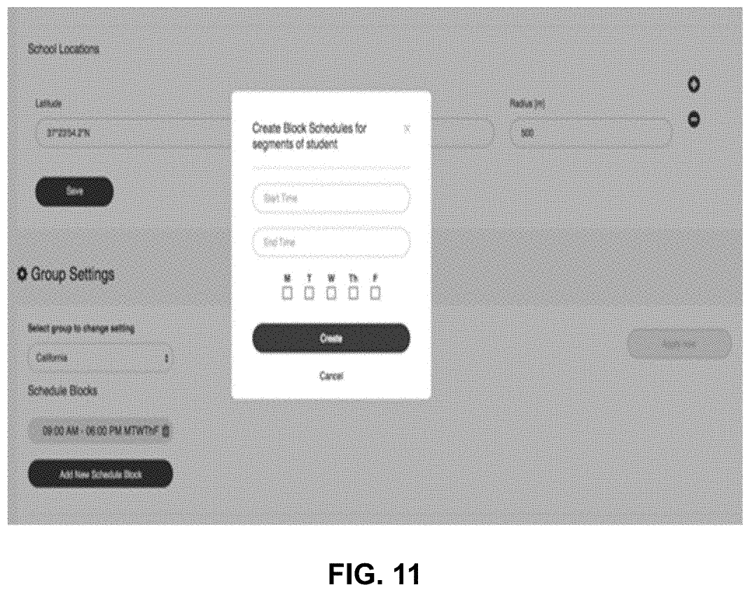

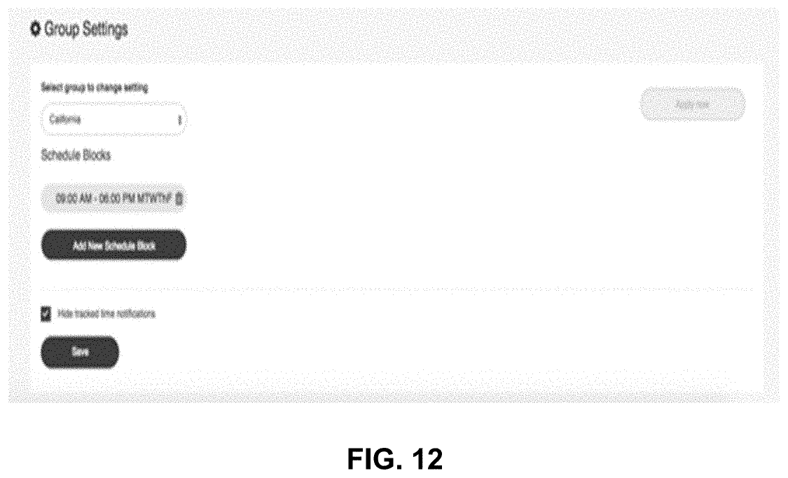

Referring to FIGS. 6-16, exemplary graphical user interfaces (GUI) of the application (shown as ClassMode) of the present disclosure are illustrated. FIG. 7 is an exemplary Home Page user interface 700 for an administrator. The GUI 700 may include an ‘on/off’ switch 702 that can activate or deactivate the application across an entire school or workplace. For example, this may be used for events like field trips or snow days. The GUI 700 may also include ‘alerts’ section 704 that tells the administrator of any issues the application is having contacting student phones. For example, this may be where the administrator will see if a student has deleted the application. The GUI 700 may also include a statistics chart 706 (shown toward the bottom of the page) showing school-wide average usage of smartphones in minutes per day, by grade level. It can be adjusted to focus on a specific date range. The GUI 700 may be configured for other usages and environments (e.g., workplaces).

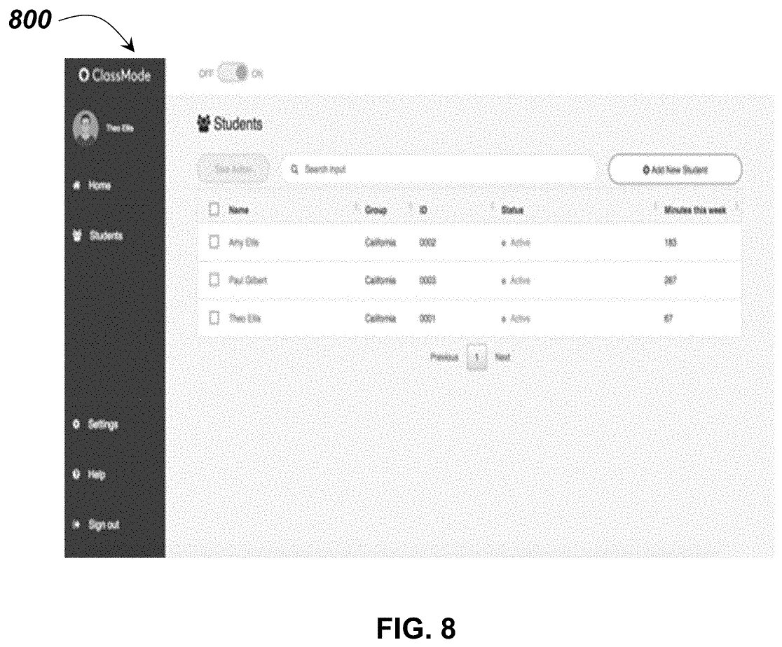

FIG. 8 illustrates an exemplary Student Roster user interface 800. An administrator may see a full list of students enrolled in the application. Students may be added individually or in bulk by CSV upload. Students may be invited via their email address or their student ID (e.g., they click a unique link in the email to download the application). The student's name, group (e.g., a grade), status, and minutes for the prior week may be shown on GUI 800. The GUI 800 may be configured for other usages and environments (e.g., workplaces).

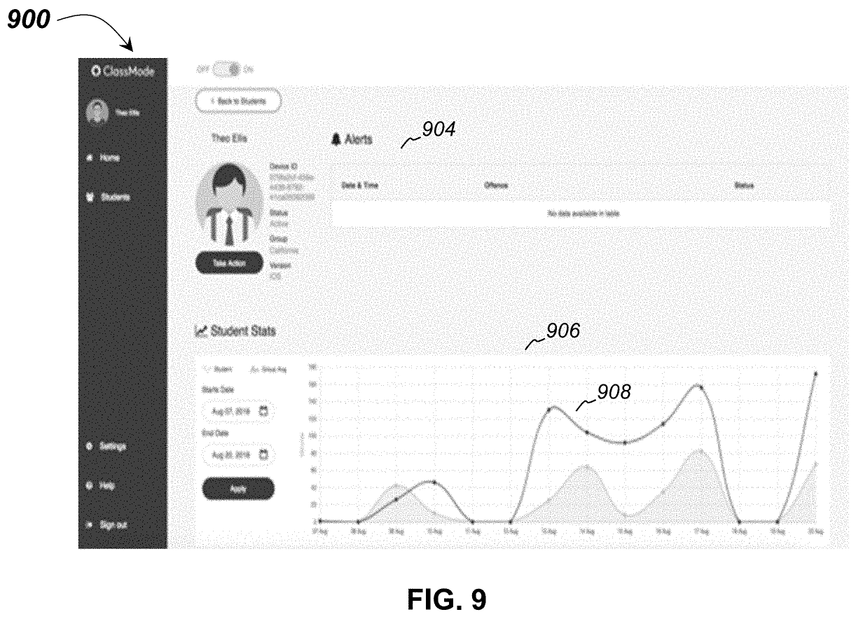

FIG. 9 is an exemplary Student Details user interface 900. In some embodiments, when a user clicks on a student's name in one or more other GUIs, the system may display the detail page 900. GUI 900 may include a student's history of alerts 904 (showing, e.g., a history of deleting the application, if the student has routinely tried to avoid using application, etc.). GUI 900 may also include a chart 906 showing the student's average usage per day over a customizable time span. There may also be a line 908 comparing this usage with the grade average. The administrator can resend a student an invite or enable/disable their device from this screen. The GUI 900 may be configured for other usages and environments (e.g., workplaces).

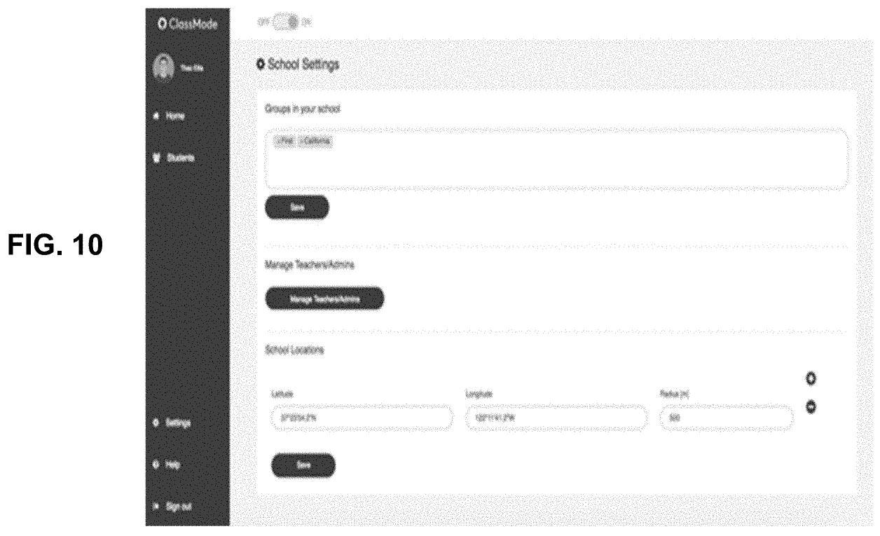

FIGS. 10-12 illustrate exemplary Settings user interfaces. The settings pages may provide the administrator with powerful tools to shape student smartphone use. The GUIs may be configured for other usages and environments (e.g., workplaces). In some embodiments, the first thing they can do is create “groups”. These are typically grade levels, but they could also be groups for things like A/B/C/D days or Upper/Lower school. Teachers and administrators can be added to the application. It may be set up so that teachers have “read only” access, administrators can change settings. The latitude and longitude of the geofence: application may only be actively counting minutes when the user's phone indicates it is within the defined geofence. The administrator may create several geofences in case there are multiple campus locations. A range can also be set around the geofence to account for the size of a large campus.

In some embodiments the administrator can set different screen time usage parameters for different grades. For instance, 8^{th} graders could have a policy of only 20 minutes of screen time during the school day, while 12^{th} graders might be on a ‘tracking only’ mode that simply alerts them of how much they are using their devices every day. The following options may be available to the administrator to set for each group:

(1) Schedule blocks for when application periods are active (e.g., can be set by hours and days of the week, and automatically recur weekly).

(2) Set a threshold number of minutes after which the phone will be blocked (e.g. if the phone is used more than 20 minutes during the application periods, the phone will be blocked.

(3) Tracked time notifications: the user can send ‘push’ notifications to the app user to alert them how long they have been on their device. These can be helpful reminders to curb usage.

(4) The settings can be applied immediately or the following day.

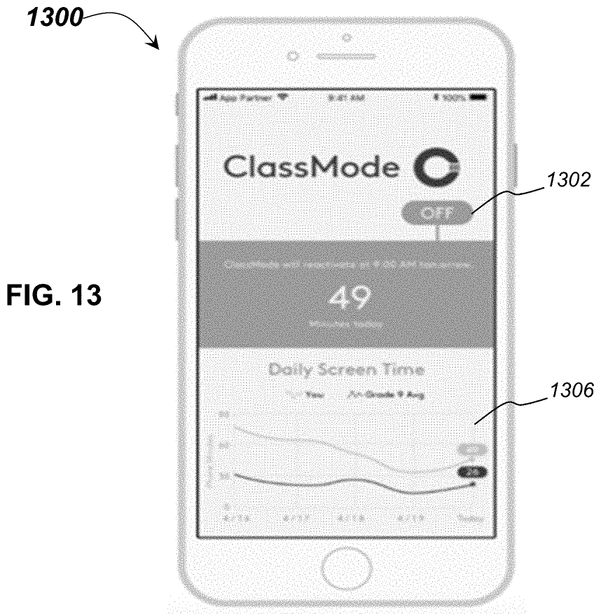

FIGS. 13-16 illustrate exemplary user interfaces as displayed on mobile devices. As shown in GUI 1300 in FIG. 13, when the application is inactive (e.g., not in an application period, for example after school or on the weekends) as indicated with status 1302, the only thing that may be visible in the app may be the number of minutes of screen time from the prior day at school. A chart 1304 shows the student's trend line of usage compared with their grade average.

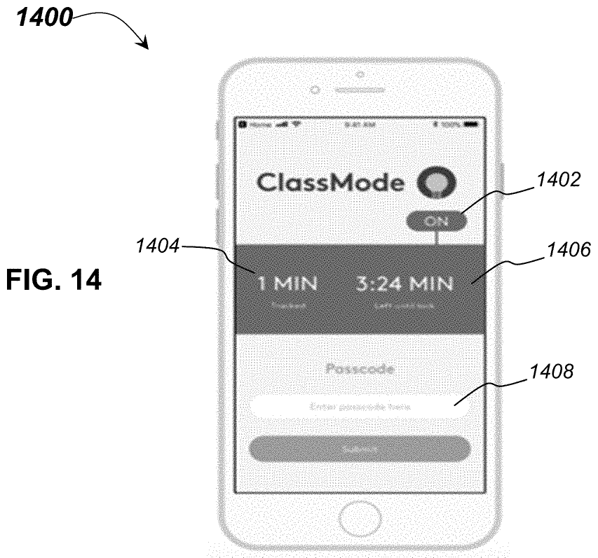

As shown in GUI 1400 in FIG. 14, when the application is active (e.g., on campus during an application period) as indicated with status 1402, the application displays at 1404 how many minutes the user has been on the device that day, and at 1406 the number of minutes remaining before the user is “blocked”. There may also be an area 1408 for the user to enter the Passcode that will temporarily disable the application.

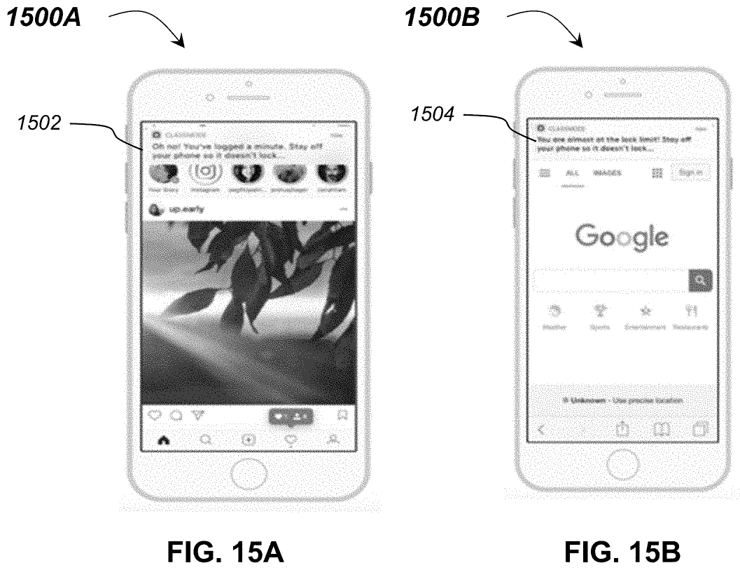

As shown in GUI 1500A and 1500B in FIGS. 15A-15B, the application may send alerts 1502 to the user after the user has logged a certain number of minutes. The message and frequency of this notification can be set by the administrator. The application may also send an alert (1504) before it blocks the phone, for example 1 minute before it blocks.

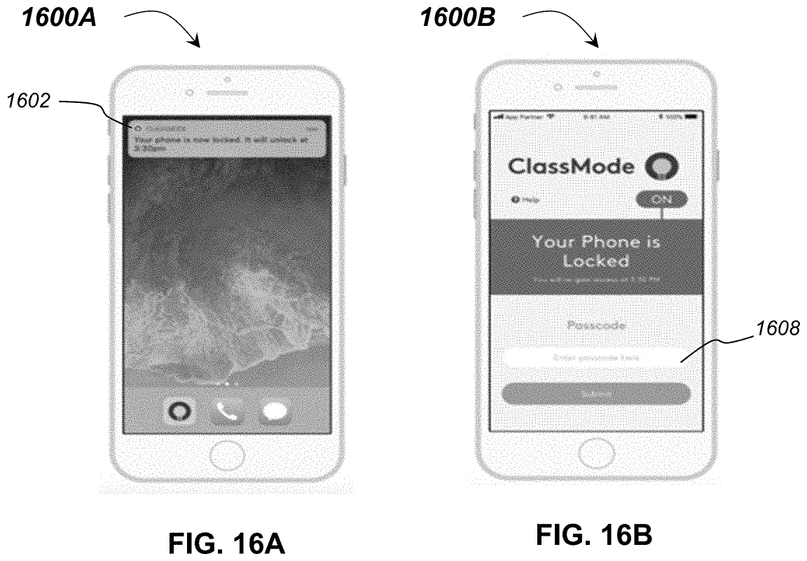

As shown in GUI 1600A and 1600B in FIGS. 16A-16B, when the “block” limit is about to reached or is reached, the application may alert (at 1602) the user. In some embodiments, during the blocked state, all third-party apps, the Internet, and the camera may be disabled. All that remains may be voice calling, text messaging, and some native functions (e.g., the calculator). If the user goes into the application, the user can enter a Passcode (at 1608) to unblock the phone.

As mentioned above, it should be noted that although various examples used above relate to schools, the present disclosure also applies to workplaces and other environments. For example, in a workplace, the present disclosure may help employers measure how much time their employees are spending on their phones during their shifts. Users of the system may be employers of hourly workers in industries like security, retail, warehouses, restaurants, construction, and manufacturing. The benefits in the workplace may include:

Enhanced productivity. Currently, the average worker spends 56 minutes a day on non-work activities on their smartphone. The application, by managing or controlling phone usage, may help improve this.

Fewer accidents: Workplace injuries lead to tens of billions of dollars of workers compensation claims annually. Accidents are 4 times more likely when employees are on their smartphones. Managing or controlling phone usage many reduce the number of accidents.

Improved customer service: The application of the present disclosure may provide a qualitative improvement to customer service when employees are attentive to customers the moment they walk into a business.

Documenting compliance with regulatory and insurance-mandated safety requirements in the workplace. For example, many high-risk jobs prohibit the use of smartphones in the workplace. Using the application may give an employer a means to document compliance to regulators or their workers' compensation employer.

In some other embodiments, the application may be geared more towards individual and social use. This would incorporate the same underlying technology as described above but, for example, instead of a principal or employer acting as administrator, individuals would compete against their friends to reduce screen time during various periods of the day.

Additionally, the present disclosure also includes systems and methods for validating the data received and/or acquired before use.

System Architecture

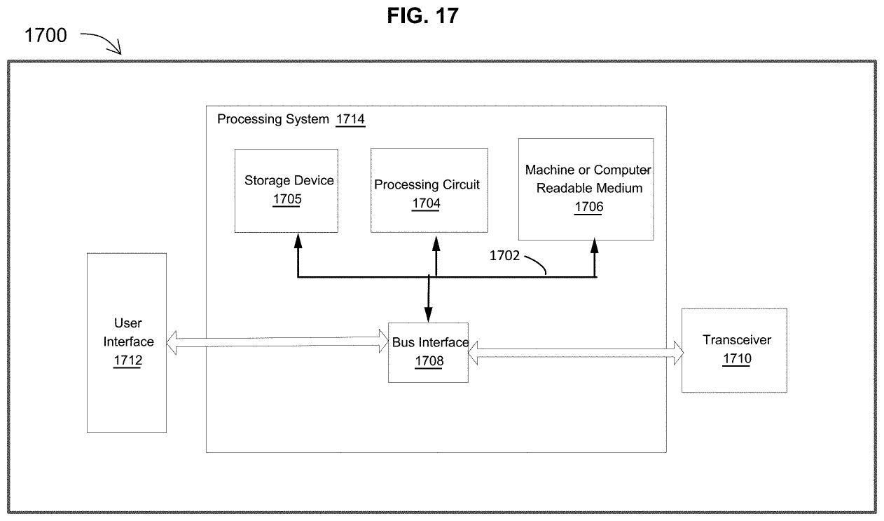

FIG. 17 illustrates an exemplary overall system architecture 1700 in which various embodiments and process steps disclosed herein can be implemented. In accordance with various aspects of the disclosure, an element, or any portion of an element, or any combination of elements may be implemented with a processing system 1714 that includes one or more processing circuits 1704. Processing circuits 1704 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 1704 may be used to implement any one or more of the various embodiments, systems, algorithms, and processes described above, as illustrated in at least FIGS. 3-5.

In the example of FIG. 17, the processing system 1714 may be implemented with a bus architecture, represented generally by the bus 1702. The bus 1702 may include any number of interconnecting buses and bridges depending on the specific application of the processing system 1714 and the overall design constraints. The bus 1702 may link various circuits including one or more processing circuits (represented generally by the processing circuit 1704), the storage device 1705, and a machine-readable, processor-readable, processing circuit-readable or computer-readable media (represented generally by a non-transitory machine-readable medium 1709). The bus 1702 may also link various other circuits such as timing sources, peripherals, voltage regulators, and power management circuits, which are well known in the art, and therefore, will not be described any further. The bus interface 1708 may provide an interface between bus 1702 and a transceiver 1713. The transceiver 1710 may provide a means for communicating with various other apparatus over a transmission medium. Depending upon the nature of the apparatus, a user interface 1712 (e.g., keypad, display, speaker, microphone, touchscreen, motion sensor) may also be provided.

The processing circuit 1704 may be responsible for managing the bus 1702 and for general processing, including the execution of software stored on the machine-readable medium 1709. The software, when executed by processing circuit 1704, causes processing system 1714 to perform the various functions described herein for any particular apparatus. Machine-readable medium 1709 may also be used for storing data that is manipulated by processing circuit 1704 when executing software.

One or more processing circuits 1704 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The embodiments of the present disclosure provide for improvements over prior modes in the field of in-movie early warning system. These improvements can include, for example, optimization of computer resources, improved data accuracy and improved data integrity, to name only a few. In a number of embodiments, instructions stored in the memory of computing devices (e.g., software) can cause one or more processors of the system to perform the steps of the embodiments described herein, illustrated in at least FIGS. 3-5.

The embodiments of the present disclosure provide for improvements over prior modes in the field of managing and controlling a device based on location. These improvements can include, for example, optimization of computer resources, improved data accuracy and improved data integrity, to name only a few. In a number of embodiments, instructions stored in the memory of computing devices (e.g., software) can cause one or more processors of the system perform the steps of the embodiments disclosed herein.

The improvements of the present disclosure are necessarily rooted in computer-based systems for managing and controlling a device based on location, and in some embodiments may include tracking creation and modification of digital records using consensus-driven blockchain or semi-private blockchain. Additionally, many of the embodiments disclosed herein reflect an inventive concept in the particular arrangement and combination of the devices, components and method steps utilized for managing and controlling a device based on location.

In some embodiments, the system of the present disclosure may batch updates from the mobile device to the server to conserve network and battery capacity.

In some embodiments, the system of the present disclosure may upload groups of users and admins in bulk via a CSV or using a web-based form. The system may also use an individualized email link to activate a device (pairs the student's phone with a particular school).

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

1. A computer-based method for managing and controlling a user device based on location, comprising:
defining one or more policy definitions;
storing the one or more policy definitions in a database;
activating an application on the user device based on the location of the user device;
retrieving the one or more policy definitions;
receiving telemetry information of the user device, wherein the telemetry information includes at least screen time data;
updating status of the user device in the database, based on the telemetry information;
transmitting a push notification to the user device; and
locking the user device based on the one or more policy definitions.

2. The computer-based method of claim 1, wherein the location of the user device indicates the user device enters a defined geographic area.

3. The computer-based method of claim 1, wherein receiving telemetry information of the user device periodically.

4. The computer-based method of claim 1, wherein the one or more policy definitions include at least one of a period of time the application can be activated, activities allowed when the application is activated, actions to perform when the user device is not in compliance, and geofencing configurations.

5. The computer-based method of claim 4, wherein the period of time the application can be activated includes one or more blocks of time a user of the user device is in class.

6. The computer-based method of claim 4, wherein the period of time the application can be activated includes one or more blocks of time a user of the user device is at work.

7. The computer-based method of claim 4, wherein the actions to perform when the user device is not in compliance include one of locking the user device, transmitting a warning to the user device, and notifying a third person.

8. The computer-based method of claim 4, wherein the user is not in compliance based on one of the user attempting to tamper with or disable the application, or the user disabling a location service on the user device.

9. The computer-based method of claim 1 further comprising providing a randomly generated passcode to disable the locking of the user device.

10. The computer-based method of claim 1, wherein locking the user device includes disabling at least one of one or more third-party applications, Internet connection, and a camera.

11. The computer-based method of claim 1, wherein locking the user device does not includes disabling at least one of voice calling, text messaging, and one or more native functions of the user device.

12. A system for managing and controlling a user device based on location, the system comprises one or more processors configured to:
defining one or more policy definitions;
storing the one or more policy definitions in a database;
activating an application on the user device based on the location of the user device;
retrieving the one or more policy definitions;
receiving telemetry information of the user device, wherein the telemetry information includes at least screen time data;
updating status of the user device in the database, based on the telemetry information;
transmitting a push notification to the user device; and
locking the user device based on the one or more policy definitions.

13. The system of claim 12, wherein the location of the user device indicates the user device enters a defined geographic area.

14. The system of claim 12, wherein the one or more policy definitions include at least one of a period of time the application can be activated, activities allowed when the application is activated, actions to perform when the user device is not in compliance, and geofencing configurations.

15. The system of claim 14, wherein the period of time the application can be activated includes one or more blocks of time a user of the user device is in class.

16. The system of claim 14, wherein the period of time the application can be activated includes one or more blocks of time a user of the user device is at work.

17. The system of claim 14, wherein the actions to perform when the user device is not in compliance include one of locking the user device, transmitting a warning to the user device, and notifying a third person.

18. The system of claim 14, wherein the user is not in compliance based on one of the user attempting to tamper with or disable the application, or the user disabling a location service on the user device.

19. The system of claim 12 further comprising providing a randomly generated passcode to disable the locking of the user device.

20. The system of claim 12, wherein locking the user device includes disabling at least one of one or more third-party applications, Internet connection, and a camera.
